(19) United States
(12) Patent Application Publication
(10) Pub. No.: US 2025/0142368 A1
(43) Pub. Date: May 1, 2025

(54) WIRELESS COMMUNICATION METHOD AND COMMUNICATIONS DEVICE

(71) Applicant: GUANGDONG OPPO MOBILE TELECOMMUNICATIONS CORP., LTD., Dongguan (CN)

(72) Inventors: Jing XU, Dongguan (CN); Yanan LIN, Dongguan (CN); Bin LIANG, Dongguan (CN); Yi ZHANG, Dongguan (CN)

(73) Assignee: GUANGDONG OPPO MOBILE TELECOMMUNICATIONS CORP., LTD., Dongguan (CN)

(21) Appl. No.: 19/006,751

(22) Filed: Dec. 31, 2024

Related U.S. Application Data
(63) Continuation of application No. PCT/CN2022/103446, filed on Jul. 1, 2022.

(51) Int. Cl. H04W 24/02; H04L 5/00; H04W 16/28

(52) U.S. Cl. CPC H04W 24/02; H04L 5/0051; H04L 5/0091; H04W 16/28

(57) ABSTRACT

A wireless communication method and a communications device are provided. The method includes: receiving, by a first device, a first reference signal from a second device based on configuration information of the first reference signal; and sending, by the first device, a second reference signal to the second device based on configuration information of the second reference signal, where the first reference signal and the second reference signal are respectively used to determine first channel information and second channel information, and the first channel information and the second channel information are the same. In the foregoing solution, the first device determines the first channel information based on the first reference signal, and the second device determines the second channel information based on the second reference signal.

### CROSS-REFERENCE TO RELATED APPLICATIONS

This application is a continuation of International Application No. PCT/CN2022/103446, filed on Jul. 1, 2022, the disclosure of which is hereby incorporated by reference in its entirety.

### TECHNICAL FIELD

This application relates to the field of communications technologies, and more specifically, to a wireless communication method and a communications device.

### RELATED ART

In a communications system, two communication parties determine channel information based on reference signals in different transmission directions. For example, a terminal device receives a downlink reference signal to determine channel information of a downlink. In addition, the terminal device sends an uplink reference signal to a network device, so that the network device determines channel information of an uplink based on the uplink reference signal. A manner of determining channel information provided in related technologies cannot meet security requirements of transmission.

### SUMMARY

This application provides a wireless communication method and a communications device. Various aspects involved in this application are described below.

According to a first aspect, a wireless communication method is provided. The method includes: receiving, by a first device, a first reference signal from a second device based on configuration information of the first reference signal; and sending, by the first device, a second reference signal to the second device based on configuration information of the second reference signal, where the first reference signal and the second reference signal are respectively used to determine first channel information and second channel information, and the first channel information and the second channel information are the same.

According to a third aspect, a communications device is provided. The communications device is a first device. The communications device includes: a receiving module, configured to receive a first reference signal from a second device based on configuration information of the first reference signal; and a sending module, configured to send a second reference signal to the second device based on configuration information of the second reference signal, where the first reference signal and the second reference signal are respectively used to determine first channel information and second channel information, and the first channel information and the second channel information are the same.

According to a fourth aspect, a communications device is provided. The communications device is a second device. The communications device includes: a sending module, configured to send a first reference signal to a first device based on configuration information of the first reference signal; and a receiving module, configured to receive a second reference signal from the first device based on configuration information of the second reference signal, where the first reference signal and the second reference signal are respectively used to determine first channel information and second channel information, and the first channel information and the second channel information are the same.

In embodiments of this application, a first device determines first channel information based on a first reference signal, and a second device determines second channel information based on a second reference signal.

### BRIEF DESCRIPTION OF DRAWINGS

FIG. 1 is a diagram of a system architecture of a communications system to which an embodiment of this application is applicable.

FIG. 2 is a schematic flowchart of a wireless communication method according to an embodiment of this application.

FIG. 3 is a schematic diagram of a structure of a communications device according to an embodiment of this application.

FIG. 4 is a schematic diagram of a structure of a communications device according to another embodiment of this application.

FIG. 5 is a schematic diagram of a structure of an apparatus according to an embodiment of this application.

### DESCRIPTION OF EMBODIMENTS

Embodiments of this application may be applied to various communications systems. For example, embodiments of this application may be applied to a Global System for Mobile Communications (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a universal mobile telecommunications system (UMTS), a wireless local area network (WLAN), wireless fidelity (Wi-Fi), and a 5th generation (5G) communications system. Embodiments of this application may be further applied to another communications system, such as a future communications system. The future communications system may be, for example, a 6th generation (6G) mobile communications system, or a satellite communications system.

Conventional communications systems support a limited number of connections and are also easy to implement. However, with the development of communications technologies, a communications system may support not only conventional cellular communication but also one or more types of communication in another type. For example, the communications system may support one or more types of the following communication: device-to-device (D2D) communication, machine-to-machine (M2M) communication, machine type communication (MTC), vehicle-to-vehicle (V2V) communication, vehicle-to-everything (V2X) communication, and the like. Embodiments of this application may also be applied to a communications system that supports the foregoing communication manners.

The communications system in embodiments of this application may be applied to a carrier aggregation (CA) scenario, a dual connectivity (DC) scenario, or a standalone (SA) networking scenario.

The communications system in embodiments of this application may be applied to an unlicensed spectrum. The unlicensed spectrum may also be considered as a shared spectrum. Alternatively, the communications system in embodiments of this application may be applied to a licensed spectrum. The licensed spectrum may also be considered as a dedicated spectrum.

Embodiments of this application may be applied to a terrestrial network (TN) system, or may be applied to a non-terrestrial network (NTN) system. As an example, the NTN system may include an NR-based NTN system and an Internet of Things (IoT)-based NTN system.

The communications system may include one or more terminal devices. The terminal device mentioned in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, a user apparatus, or the like.

In some embodiments, the terminal device may be a station (ST) in a WLAN. In some embodiments, the terminal device may alternatively be a cellular phone, a cordless phone, a session initiation protocol (SIP) phone, a wireless local loop (WLL) station, a personal digital assistant (PDA) device, a handheld device having a wireless communication function, a computing device or any other processing device connected to a wireless modem, a vehicle-mounted device, a wearable device, a terminal device in a next generation communications system (such as an NR system) or a terminal device in a future evolved public land mobile network (PLMN), or the like.

In some embodiments, the terminal device may be a device providing a user with voice and/or data connectivity. For example, the terminal device may be a handheld device, a vehicle-mounted device, or the like having a wireless connection function. In some specific examples, the terminal device may be a mobile phone, a tablet computer (pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, and a satellite.

In addition to the terminal device, the communications system may further include one or more network devices. The network device in embodiments of this application may be a device for communicating with the terminal device. The network device may also be referred to as an access network device or a wireless access network device. The network device may be, for example, a base station. The network device in embodiments of this application may be a radio access network (RAN) node (or device) that connects the terminal device to a wireless network. The access network device may broadly cover the following various names, or may be replaced with the following names: a NodeB (NodeB), an evolved NodeB (eNB), a next generation NodeB (gNB), a relay station, an access point, a transmitting and receiving point (TRP), a transmitting point (TP), a master eNode MeNB, a secondary eNode SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device to device D2D, vehicle-to-everything (V2X), and machine-to-machine (M2M) communications, a network-side device in a 6G network, a device that functions as a base station in a future communications system, or the like. The base station may support networks of the same or different access technologies. A specific technology and specific device used by the network device are not limited in embodiments of this application.

The base station may be fixed or mobile. For example, a helicopter or an unmanned aerial vehicle may be configured to function as a mobile base station, and one or more cells may move according to a location of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

As an example rather than limitation, in embodiments of this application, the network device may have a mobile feature, for example, the network device may be a movable device. In some embodiments of this application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of this application, the network device may alternatively be a base station located on land, water, or the like.

In embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell. The small cell herein may include: a metro cell, a micro cell, a pico cell, a femto cell, or the like. These small cells feature small coverage and low transmit power, and are suitable for providing a high-speed data transmission service.

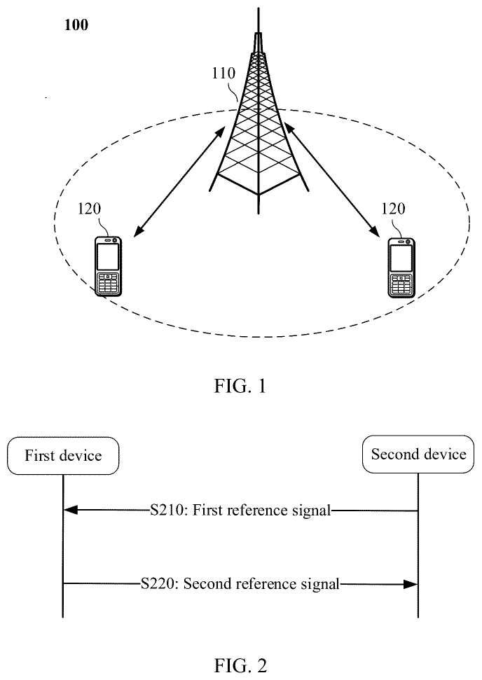

For example, FIG. 1 is a schematic diagram of an architecture of a communications system according to an embodiment of this application. As shown in FIG. 1, a communications system 100 may include a network device 110, and the network device 110 may be a device that communicates with a terminal device 120 (or referred to as a communications terminal or a terminal). The network device 110 may provide communication coverage for a specific geographic area, and may communicate with a terminal device within the coverage area.

FIG. 1 exemplarily shows one network device and two terminal devices. In some embodiments of this application, the communications system 100 may include a plurality of network devices and another number of terminal devices may be included within a coverage area of each network device, which is not limited in embodiments of this application.

In some embodiments of this application, the wireless communications system shown in FIG. 1 may further include another network entity such as a mobility management entity (MME) or an access and mobility management function (AMF), which is not limited in the embodiment of this application.

It should be understood that a device having a communication function in a network/system in embodiments of this application may be referred to as a communications device. The communications system 100 shown in FIG. 1 is used as an example. A communications device may include the network device 110 and the terminal device 120 having a communication function, and the network device 110 and the terminal device 120 may be specific devices described above, and details are not described herein. The communications device may further include other devices in the communications system 100, such as a network controller, a mobility management entity, and other network entities, which is not limited in embodiments of this application.

With development of communications technologies, a physical layer security solution based on channel information may be introduced into a communications system. In the physical layer security solution, user-specific information may be generated based on dynamically changing channel information. Then, two communication parties may encrypt or scramble a signal based on the user-specific information, thereby improving security of signal transmission. Implementation of the physical layer security solution based on channel information requires that two communication parties can know channel information of each other. Otherwise, a receiver may not be able to decrypt or descramble a signal transmitted by a sender. However, as described above, for a reference signal provided in related technologies, channel information in only one transmission direction can be obtained, thus being not conducive to the implementation of the physical layer security solution based on the channel information.

A wireless communication method provided in an embodiment of this application is described in detail below with reference to FIG. 2.

The method of FIG. 2 may be performed by a first device and a second device. The first device and the second device may be any two communications devices in a communications system. For example, in some embodiments, the first device and the second device may be respectively a terminal device and a network device. Correspondingly, a communication link from the first device to the second device is an uplink and a communication link from the second device to the first device is a downlink. As another example, in some embodiments, the first device and the second device may both be terminal devices. Correspondingly, a communication link from the first device to the second device and a communication link from the second device to the first device are both sidelinks.

Reference is made to FIG. 2. In Step S210 and Step S220, the first device receives a first reference signal from a second device based on configuration information of the first reference signal, and sends a second reference signal to the second device based on configuration information of the second reference signal.

The first reference signal and the second reference signal in FIG. 2 are reference signals with different transmission directions. The first reference signal is a reference signal transmitted along a communication link from the second device to the first device, and the second reference signal is a reference signal transmitted along a communication link from the first device to the second device. For example, the first device and the second device are respectively a terminal device and a network device. Then, the first reference signal and the second reference signal are respectively a downlink reference signal and an uplink reference signal. For example, both the first device and the second device are terminal devices. Then, the first reference signal and the second reference signal are sidelink reference signals with different transmission directions.

In some embodiments, the first reference signal includes a channel state information reference signal (CSI-RS). The CSI-RS may be a CSI-RS corresponding to a downlink, or a CSI-RS corresponding to a sidelink.

In some embodiments, the second reference signal includes a sounding reference signal (SRS). The SRS may be an SRS corresponding to an uplink or an SRS corresponding to a sidelink.

In some embodiments, the first reference signal and the second reference signal in FIG. 2 are respectively used to determine first channel information and second channel information, and the first channel information and the second channel information are the same. That is, the first reference signal and the second reference signal may be used to determine the same channel information. Because the first channel information and the second channel information are the same, the first device and the second device both obtain channel information of each other, thereby being conducive to implement the physical layer security solution based on the channel information.

In some embodiments, the first channel information may indicate a channel state between the first device and the second device. Therefore, in this embodiment, the first channel information may also be replaced with first channel state information.

In some embodiments, the first channel information may be part or all of information in a channel matrix between the first device and the second device; or the first channel information may be information determined based on the channel matrix. For example, the channel matrix between the first device and the second device may be represented by an amplitude and a phase, and the first channel information may be amplitude information of the channel matrix, may be phase information of the channel matrix, or may be information determined based on amplitude information or phase information of the channel matrix. For example, a phase of the channel matrix may be quantized to obtain the first channel information. For a more detailed description of the first channel information, one may refer to Embodiment 1 and Embodiment 2 below.

In some embodiments, the second channel information may indicate a channel state between the first device and the second device. Therefore, in this embodiment, the second channel information may also be replaced with second channel state information.

In some embodiments, the second channel information may be part or all of information in a channel matrix between the first device and the second device; or the second channel information may be information determined based on the channel matrix. For example, the channel matrix between the first device and the second device may be represented by an amplitude and a phase, and the second channel information may be amplitude information of the channel matrix, may be phase information of the channel matrix, or may be information determined based on amplitude information or phase information of the channel matrix. For example, a phase of the channel matrix may be quantized to obtain the second channel information. For a more detailed description of the second channel information, one may refer to Embodiment 1 and Embodiment 2 below.

In some embodiments, the first reference signal and the second reference signal in FIG. 2 may be understood as reference signals for a first link. The first link mentioned herein may be a communication link in two transmission directions. The two transmission directions may include a first transmission direction from the first device to the second device and a second transmission direction from the second device to the first device. Therefore, in some embodiments, the first link may be referred to as a bidirectional link.

Further, in some embodiments, a reference signal set including the first reference signal and the second reference signal may be referred to as a bidirectional reference signal. The bidirectional reference signal may be a newly introduced reference signal (for example, a new reference signal introduced by the standard to support a physical layer security solution), or may be a pair of reference signals formed by associating existing reference signals with different transmission directions.

In some embodiments, there is an association between spatial information of the first reference signal and spatial information of the second reference signal. Spatial information of a signal may include one or more of: an antenna pattern corresponding to a transmitted signal and an antenna pattern corresponding to a received signal. The antenna pattern corresponding to the transmitted signal may include, for example, one or more of: an amplitude of a transmitting antenna, an amplitude adjustment amount of the transmitting antenna, a phase of the transmitting antenna, or a phase adjustment amount of the transmitting antenna. Different antenna patterns result in different energy distribution of transmitted signals in space. Usually, energy distribution of a signal in space is referred to as a beam. Therefore, the antenna pattern corresponding to the transmitted signal may also be expressed by a transmitted beam of the signal. The antenna pattern corresponding to the received signal may include, for example, one or more of: an amplitude of a receiving antenna, an amplitude adjustment amount of the receiving antenna, a phase of the receiving antenna, or a phase adjustment amount of the receiving antenna. Different antenna patterns result in different energy of signals received in different directions in space. Therefore, the antenna pattern corresponding to the received signal may also be expressed by a received beam of the signal.

In some embodiments, the spatial information of the first reference signal may include transmission configuration indicator (TCI) information, such as a TCI index, of the first reference signal. In some embodiments, the spatial information of the second reference signal may include TCI information, such as a TCI index, of the second reference signal.

In some embodiments, an association between spatial information of the first reference signal and spatial information of the second reference signal may include: that the spatial information of the first reference signal is associated to the second reference signal. For example, the configuration information of the first reference signal may include the spatial information, and the spatial information is associated to or points to the second reference signal. As a specific example, the configuration information of the first reference signal includes a first TCI index, and the first TCI index is associated to the second reference signal.

In some embodiments, an association between spatial information of the first reference signal and spatial information of the second reference signal may include: that the spatial information of the second reference signal is associated to the first reference signal. For example, the spatial information may be configured in the configuration information of the second reference signal, and the spatial information is associated to or points to the first reference signal. As a specific example, the configuration information of the second reference signal includes a second TCI index, and the second TCI index is associated to the first reference signal.

As an example, an association between spatial information of the first reference signal and spatial information of the second reference signal may include one or more of: that a received beam of the first reference signal is the same as a transmitted beam of the second reference signal, that a transmitted beam of the first reference signal is the same as a received beam of the second reference signal, or that the TCI information of the first reference signal is the same as the TCI information of the second reference signal.

In some embodiments, there is an association between frequency domain information (such as a frequency domain location) of the first reference signal and frequency domain information (such as a frequency domain location) of the second reference signal. For example, the frequency domain location of the first reference signal is the same as the frequency domain location of the second reference signal.

In some embodiments, there may be an association between the spatial information of the first reference signal and the spatial information of the second reference signal, and there may be an association between the frequency domain information of the first reference signal and the frequency domain information of the second reference signal. For example, the spatial information of the first reference signal is the same as the spatial information of the second reference signal, and the frequency domain information of the first reference signal is also the same as the frequency domain information of the second reference signal.

In some embodiments, in addition to the spatial information (or frequency domain information) of the first reference signal and the spatial information (or frequency domain information) of the second reference signal, there may be another association between the first reference signal and the second reference signal. For example, there may be an association between the first reference signal and the second reference signal in terms of one or more of transmit power, a period, or other parameter.

In some embodiments, both the first reference signal and the second reference signal may be used to generate user-specific information (or referred to as a user-specific parameter). The user-specific information may refer to a signal specific to the first device and the second device. The specific signal may be, for example, a signal that cannot be interpreted by devices other than the first device and the second device.

In some embodiments, the user-specific information may be used to scramble or encrypt a signal transmitted between the first device and the second device. Therefore, in some embodiments, the user-specific information may also be replaced with encrypted information. For example, the user-specific information may be a key.

In some embodiments, the user-specific information may be a target sequence. For example, the target sequence may include one or more of: a reference signal sequence, a base sequence for generating a reference signal sequence, or a scrambling code sequence (which may be used to scramble a physical layer data channel and/or a physical layer control channel). As an example, the target sequence may be a demodulation reference signal (DMRS) sequence, a CSI-RS sequence, or the like.

In some embodiments, the first device may generate the first channel information based on the first reference signal, and then generate the user-specific information based on the first channel information. The first device may generate the user-specific information based on the first channel information in a plurality of manners. The manners are described in detail with reference to a plurality of embodiments below, and details are not described herein.

In some embodiments, the second device may generate the second channel information based on the second reference signal, and then generate the user-specific information based on the second channel information. The second device may generate the user-specific information based on the second channel information in a plurality of manners. The manners are described in detail with reference to a plurality of embodiments below, and details are not described herein.

In some embodiments, before Step S210, the first device may receive the configuration information of the first reference signal. For example, the first device may receive the configuration information of the first reference signal from the second device. For example, the first device may receive the configuration information of the first reference signal from the second device through a PDSCH. For another example, the first device may receive the configuration information of the first reference signal from the second device through higher layer signalling (such as RRC signalling).

In some embodiments, before Step S220, the first device may receive the configuration information of the second reference signal. For example, the first device may receive the configuration information of the second reference signal from the second device. For example, the first device may receive the configuration information of the second reference signal from the second device through a PDSCH. For another example, the first device may receive the configuration information of the second reference signal from the second device through higher layer signalling (such as RRC signalling).

In some embodiments, the configuration information of the first reference signal and the configuration information of the second reference signal are both configuration information for the first link. The first link mentioned herein is a communication link in two transmission directions. The two transmission directions may include a first transmission direction from the first device to the second device and a second transmission direction from the second device to the first device. In some embodiments, the first link may also be referred to as a bidirectional link.

In some embodiments, the configuration information of the first reference signal may include one or more of the following information of the first reference signal: time domain information (such as a time domain location), the frequency domain information (such as the frequency domain location), the spatial information, power information, or a port mapping mode.

In some embodiments, the time domain information of the first reference signal may include one or more of the following information of the first reference signal: a period, an offset, or a symbol location within a slot.

In some embodiments, the frequency domain information of the first reference signal may include one or more of the following information of the first reference signal: a start resource block (resource block, RB), a transmission bandwidth, or frequency hopping information.

In some embodiments, the spatial information of the first reference signal may include the TCI index of the first reference signal.

In some embodiments, the power information of the first reference signal may include a power offset value of the first reference signal.

In some embodiments, the port mapping mode of the first reference signal may be code division multiplexing (CDM) or frequency division multiplexing (FDM).

A configuration parameter of the first reference signal is described in more detail below by using an example in which the first reference signal is a CSI-RS. For details, one may refer to Embodiment 3.1 below.

In some embodiments, the configuration information of the second reference signal may include one or more of: time domain information (for example, including a time domain location), the frequency domain information (for example, including the frequency domain location), the spatial information, power information, sequence information, and a cluster index.

In some embodiments, the time domain information of the second reference signal may include one or more of the following information of the second reference signal: a period, an offset, or a symbol location within a slot.

In some embodiments, the frequency domain information of the second reference signal may include one or more of the following information of the second reference signal: a start RB, a transmission bandwidth, or frequency hopping information.

In some embodiments, the spatial information of the second reference signal may include the TCI index of the second reference signal.

In some embodiments, the power information of the second reference signal may include a power offset value of the second reference signal.

In some embodiments, the sequence information of the second reference signal may include a cyclic shift value of the second reference signal.

A configuration parameter of the second reference signal is described in more detail below by using an example in which the second reference signal is an SRS. For details, one may refer to Embodiment 3.2 below.

It is well known that communications devices in a communications system often measures channel information of a communication link by using a reference signal. For example, before sending data, a transmit end of two communication parties first obtains channel information by using a reference signal. The transmit end obtains the channel information to configure a suitable data transmission manner and/or suitable transmission resources. For example, the transmit end may select a suitable modulation and coding scheme and transmission resource block based on the channel information. For another example, for data transmission in a multi-antenna pattern, the transmit end may select a suitable precoding matrix based on the channel information, thereby improving data transmission reliability, network coverage, or transmission efficiency. In related technologies, for data transmission in one transmission direction, usually a reference signal only in the transmission direction is configured, and channel measurement in the transmission direction is performed. For example, for downlink transmission, only a downlink reference signal needs to be configured. The terminal device may measure downlink channel information based on the downlink reference signal, and feed back the downlink channel information to the network device for downlink scheduling. For another example, for uplink transmission, only an uplink reference signal needs to be configured. The network device may measure uplink channel information based on the uplink reference signal, and perform uplink scheduling by using the uplink channel information. That is, in related technologies, data transmission in different transmission directions is performed independently, and therefore, channel measurement and reference signal configuration in different transmission directions are also independent of each other.

As mentioned above, the first reference signal and the second reference signal provided in this embodiment of this application are a pair of reference signals having the same determined channel information among reference signals in different transmission directions. In order to obtain such a pair of reference signals, reference signals that can be used to determine the same channel information among reference signals in different transmission directions may be associated together in a specific manner. Reference signals in different transmission directions may be associated in a plurality of manners. Two possible association manners are given below.

### Association Manner 1: Performing Uniform Configuration on the First Reference Signal and the Second Reference Signal

In some embodiments, the first reference signal and the second reference signal may be uniformly configured. The uniform configuration of the first reference signal and the second reference may be understood as that: a configuration process of the first reference signal and a configuration process of the second reference signal are not independent configuration processes, but are a same configuration process; or the configuration information of the first reference signal and the configuration information of the second reference signal are not independent configuration information, but belong to part of overall configuration information.

In some embodiments, some or all configuration parameters of the first reference signal and the second reference signal are shared parameters (or referred to as common references) of the first reference signal and the second reference signal. For example, configuration parameters of the first reference signal and the second reference signal that have the same value may be configured as shared parameters. Because the shared parameters only need to be configured once, complexity of the configuration may be reduced. As a specific example, one or more of the following parameters of the first reference signal and the second reference signal may be configured as shared parameters: the frequency domain information (such as frequency domain location) or the spatial information. Further, in some embodiments, in addition to the shared parameters, parameters specific to the first reference signal and the second reference signal may be configured for the first reference signal and the second reference signal. For example, the time domain information (such as occupied time domain resources) corresponding to the first reference signal and the time domain information (such as occupied time domain resources) corresponding to the second reference signal may be configured as parameters specific to the first reference signal and the second reference signal. For example, the time domain resources occupied by the first reference signal may be different from the time domain resources occupied by the second reference signal.

In some embodiments, some configuration parameters of the second reference signal are determined based on the configuration information of the first reference signal. For example, the configuration information of the first reference signal includes a first configuration parameter, and a first configuration parameter of the second reference signal may be determined based on the first configuration parameter in the configuration information of the first reference signal. In this embodiment, it is unnecessary to include one specific configuration parameter or some specific configuration parameters in the configuration information of the second reference signal, thereby reducing configuration complexity of the second reference signal. The some configuration parameters mentioned in this embodiment may include configuration parameters having corresponding values (such as the same values) in the first reference signal and the second reference signal. For example, the some configuration parameters mentioned in this embodiment may include one or more of: a frequency domain location of a reference signal or spatial information (such as a TCI index) of a reference signal. As a specific example, the first reference signal and the second reference signal are respectively a downlink reference signal and an uplink reference signal, the configuration information of the downlink reference signal includes a frequency domain location, and the configuration information of the uplink reference signal does not include a frequency domain location. In an actual transmission process, the frequency domain location of the uplink reference signal may be determined based on the frequency domain location in the configuration information of the downlink reference signal. For example, the frequency domain location of the uplink reference signal may be the same as the frequency domain location of the downlink reference signal. As another specific example, the first reference signal and the second reference signal are respectively a downlink reference signal and an uplink reference signal, the configuration information of the downlink reference signal includes a TCI index, and the configuration information of the uplink reference signal does not include a TCI index. In an actual transmission process, a sending manner of the uplink reference signal may be determined based on the TCI index in the configuration information of the downlink reference signal.

In some embodiments, some configuration parameters of the first reference signal are determined based on the configuration information of the second reference signal. For example, the configuration information of the second reference signal includes a first configuration parameter, and a first configuration parameter of the first reference signal may be determined based on the first configuration parameter in the configuration information of the second reference signal. In this embodiment, it is unnecessary to include one specific configuration parameter or some specific configuration parameters in the configuration information of the first reference signal, thereby reducing configuration complexity of the first reference signal. The some configuration parameters mentioned in this embodiment may include configuration parameters having corresponding values (such as the same values) in the first reference signal and the second reference signal. For example, the some configuration parameters mentioned in this embodiment may include one or more of: a frequency domain location of a reference signal or spatial information (such as a TCI index) of a reference signal. As a specific example, the first reference signal and the second reference signal are respectively a downlink reference signal and an uplink reference signal, the configuration information of the uplink reference signal includes a frequency domain location, and the configuration information of the downlink reference signal does not include a frequency domain location. In an actual transmission process, the frequency domain location of the downlink reference signal may be determined based on the frequency domain location in the configuration information of the uplink reference signal. For example, the frequency domain location of the downlink reference signal may be the same as the frequency domain location of the uplink reference signal. As another specific example, the first reference signal and the second reference signal are respectively a downlink reference signal and an uplink reference signal, the configuration information of the uplink reference signal includes a TCI index, and the configuration information of the downlink reference signal does not include a TCI index. In an actual transmission process, a sending manner of the downlink reference signal may be determined based on the TCI index in the configuration information of the uplink reference signal.

It should be noted that the foregoing description is made by using an example in which the first reference signal and the second reference signal are uniformly configured reference signals, but even if the configuration process of the first reference signal and the configuration process of the second reference signal are independent of each other, some or all of the solutions described above may be used. For example, in some embodiments, even if the configuration process of the first reference signal and the configuration process of the second reference signal are independent of each other, some or all configuration parameters of the first reference signal and the second reference signal may be configured as shared parameters. For example, in some embodiments, even if the configuration process of the first reference signal and the configuration process of the second reference signal are independent of each other, some configuration parameters of the second reference signal may alternatively be determined based on the configuration information of the first reference signal, or some configuration parameters of the first reference signal may alternatively be determined based on the configuration information of the second reference signal.

### Association Manner 2: Independently Configuring the First Reference Signal and the Second Reference Signal, and Pairing the First Reference Signal and the Second Reference Signal

In some embodiments, the first reference signal and the second reference signal may be independently configured reference signals. That is, the configuration process of the first reference signal and the configuration process of the second reference signal may be two independent configuration processes. For example, the first reference signal and the second reference signal are respectively a downlink reference signal and an uplink reference signal. When uplink transmission needs to be performed, the uplink reference signal may be configured for the first device; and when downlink transmission needs to be performed, the downlink reference signal may be configured for the first device.

In some embodiments, the first reference signal and the second reference signal may be a pair of reference signals having a pairing relationship. The “pairing relationship” mentioned herein may also be understood as or replaced with “association” or “correspondence”.

Further, in some embodiments, the configuration information of the first reference signal may include first information for indicating the pairing relationship. The first information may indicate the pairing relationship in a plurality of manners. For example, the first information may directly indicate an identity of the second reference signal. For another example, the first information may be a first index, and the configuration information of the second reference signal may include a second index corresponding to the first index (for example, the second index has the same value as the first index). That is, the first index may indirectly indicate that there is a pairing relationship between the first reference signal and the second reference signal by using a correspondence between the first index and the second index.

Similarly, in some embodiments, the configuration information of the second reference signal may include second information for indicating the pairing relationship. The second information may indicate the pairing relationship in a plurality of manners. For example, the second information may directly indicate an identity of the first reference signal. For another example, the second information may be a second index, and the configuration information of the first reference signal may include a first index corresponding to the second index (for example, the first index has the same value as the second index). That is, the second index may indirectly indicate that there is a pairing relationship between the second reference signal and the first reference signal by using a correspondence between the first index and the second index.

In the foregoing embodiments, both the first index and the second index may be indexes specially set to associate the first reference signal with the second reference signal. Therefore, in some embodiments, the first index and the second index may be referred to as reference signal association indexes. For example, the first reference signal and the second reference signal are respectively a downlink reference signal and an uplink reference signal. The first index and the second index may be referred to as uplink and downlink reference signal association indexes.

The first information and/or the second information mentioned above may be understood as information indicating the pairing relationship of the reference signals. It should be noted that the foregoing description is made by using an example in which the indication information is part of the configuration information of the reference signal, but embodiments of this application are not limited thereto. In other embodiments, the indication information may alternatively be information other than the configuration information of the reference signal. For example, in some embodiments, the indication information may be carried by a separate message or separate signalling to indicate that the first reference signal and the second reference signal have a pairing relationship.

In addition to pairing based on the indication information, the first reference signal and the second reference signal may be paired based on other manners. For example, the first reference signal and the second reference signal may be paired based on a condition. Pairing based on a condition may be understood as follows: if the first reference signal and the second reference signal meet one or more conditions, the first reference signal and the second reference signal may be determined as a pair of reference signals having a pairing relationship; and if the first reference signal and the second reference signal do not meet the one or more conditions, the first reference signal and the second reference signal do not have a pairing relationship. For ease of description, the one or more conditions are referred to as a first condition below, and the first condition may sometimes also be referred to as a pairing condition.

In some embodiments, the first condition may be determined based on protocol predefined information, pre-configuration information, or configuration information of the network device.

Embodiments of this application impose no limitation on a specific setting manner of the first condition, as long as the same channel information can be determined for the first reference signal and the second reference signal that are paired.

In some embodiments, the first condition may be associated with one or more of: the spatial information of the first reference signal and the spatial information of the second reference signal; or the frequency domain information (such as the frequency domain location) of the first reference signal and the frequency domain information (such as the frequency domain location) of the second reference signal.

In some embodiments, the first condition may include one or more of: that the spatial information of the first reference signal is the same as the spatial information of the second reference signal; or that the frequency domain location of the first reference signal is the same as the frequency domain location of the second reference signal. Further, in some embodiments, the spatial information of the first reference signal and the spatial information of the second reference signal being the same may include one or more of: that the TCI index of the first reference signal and the TCI index of the second reference signal are the same; that the transmitted beam of the first reference signal and the received beam of the second reference signal are the same; or that the received beam of the first reference signal and the transmitted beam of the second reference signal are the same.

It should be noted that the foregoing description is made by using an example in which the first reference signal and the second reference signal are independently configured reference signals, but even if the first reference signal and the second reference signal are uniformly configured reference signals, some or all of the solutions described above may be used. For example, in some embodiments, even if the first reference signal and the second reference signal are uniformly configured reference signals, indication information (such as the first information and/or the second information described above) indicating that the first reference signal and the second reference signal have a pairing relationship may be configured. For another example, in some embodiments, even if the first reference signal and the second reference signal are uniformly configured reference signals, the first reference signal and the second reference signal may be paired based on the first condition described above.

Configuration manners of the first reference signal and the second reference signal are described in detail above. After configuration for the first reference signal and the second reference signal is completed, the first device may receive the first reference signal, and generate user-specific information based on the first reference signal. Similarly, the second device may receive the second reference signal, and generate user-specific information based on the second reference signal. In some embodiments, the user-specific information generated based on the first reference signal is the same as the user-specific information generated based on the second reference signal.

After obtaining the user-specific information, the first device and/or the second device may perform a physical layer security solution based on the user-specific information. For example, the first device and/or the second device may encrypt, based on the user-specific information, a signal transmitted between the first device and the second device.

In order to ensure that the first device and the second device use the user-specific information in a consistent manner, in some embodiments, an effective time of the user-specific information may be specified (or the effective time may be replaced by an effective time of an encryption operation, or may be replaced by an enabling time of the physical layer security solution).

In some embodiments, before the first device and the second device use the user-specific information, the effective time of the user-specific information may be negotiated.

In some embodiments, the first device and the second device may determine the effective time of the user-specific information based on a same rule to reduce signalling overheads caused by negotiating the effective time, and thus improve communication efficiency. The rule may be determined based on protocol predefined information, pre-configuration information, or configuration information of the network device.

In some embodiments, the effective time of the user-specific information may be determined based on a first reference time. The first reference time may be determined in a plurality of manners, and several specific examples are given below.

For example, the first reference time may be determined based on a transmission time of the first reference signal and/or a transmission time of the second reference signal. As a possible implementation, the first reference time may be determined based on a transmission time of a target reference signal. The target reference signal mentioned herein may be a reference signal that has a later transmission time in the first reference signal and the second reference signal, or may be a reference signal that has an earlier transmission time in the first reference signal and the second reference signal. If the transmission time of the first reference signal and the transmission time of the second reference signal are the same, the target reference signal may be the first reference signal or the second reference signal. As an example, the first reference time may be set to be equal to the transmission time of the target reference signal.

For another example, the first reference time may be determined based on a transmission time of first feedback information. The first feedback information may be used to indicate that the first device has successfully received reference signal configuration information. The reference signal configuration information mentioned in this example may include the configuration information of the first reference signal and/or the configuration information of the second reference signal mentioned above. For example, the first reference signal and the second reference signal are uniformly configured reference signals. The reference signal configuration information may include the configuration information of the first reference signal and the configuration information of the second reference signal, and the first feedback information may be feedback information (such as an acknowledgement (ACK) or a negative acknowledgement (NACK)) for the reference signal configuration information. As an example, the first reference time may be set to be equal to the transmission time of the first feedback information.

In some embodiments, the effective time of the user-specific information may be determined based on the first reference time and a preset time interval (T time units). For example, the effective time of the user-specific information may be equal to or later than a first time. The first time may be determined based on T (T is a positive integer greater than or equal to 1) time units after the first reference time.

The T time units mentioned above may be determined based on one or more factors such as actual communication conditions and processing capabilities of the first device and/or the second device.

For example, the first reference time is the transmission time of the first reference signal. After receiving the first reference signal, the first device needs to determine the user-specific information based on the first reference signal. The T time units may be set to be greater than or equal to a time consumed by the first device from a time instant of receiving the first reference signal to a time instant of determining the user-specific information. The T time units may be related to the processing capability of the first device.

For example, the first reference time is the transmission time of the second reference signal. After receiving the second reference signal, the second device needs to determine the user-specific information based on the second reference signal. The T time units may be set to be greater than or equal to a time consumed by the second device from a time instant of receiving the second reference signal to a time instant of determining the user-specific information. The T time units may be related to the processing capability of the second device.

For example, the first reference time is the transmission time of the first feedback information (the first feedback information is used to indicate that the first device has successfully received the configuration information of the first reference signal and/or the configuration information of the second reference signal). After sending the first feedback information, the first device needs to first receive the first reference signal, and then determine the user-specific information based on the first reference signal. The T time units may be set to be greater than or equal to a sum of: a time consumed by the first device from a time instant of sending the first feedback information to a time instant of receiving the first reference signal, and the time consumed by the first device from a time instant of receiving the first reference signal to a time instant of determining the user-specific information. The T time units may be related to the processing capability of the first device.

For ease of understanding, several more specific examples are given below by using an example in which the first device is a terminal device and the second device is a network device.

For example, when T time units from the transmission time of the target reference signal (the reference signal with a later transmission time in the first reference signal and the second reference signal) expires, the terminal device encrypts or scrambles the signal to be transmitted between the terminal device and the network device by using the user-specific information generated based on the first channel information.

For another example, when T time units from the transmission time of the target reference signal expires, the network device encrypts or scrambles the signal to be transmitted between the terminal device and the network device by using the user-specific information generated based on the second channel information.

For another example, after receiving the uniformly configured reference signal configuration information (including the configuration information of the first reference signal and the configuration information of the second reference signal) sent by the network device, the terminal device sends the first feedback information to the network device. If the first feedback information sent by the terminal device is an ACK and when T time units from the transmission time of the target reference signal expires, the terminal device encrypts or scrambles the signal to be transmitted between the terminal device and the network device by using the user-specific information generated based on the first channel information. Correspondingly, if the first feedback information sent by the terminal device is an ACK and when T time units from the transmission time of the target reference signal expires, the network device encrypts or scrambles the signal to be transmitted between the terminal device and the network device by using the user-specific information generated based on the second channel information.

For another example, after receiving the uniformly configured reference signal configuration information (including the configuration information of the first reference signal and the configuration information of the second reference signal) sent by the network device, the terminal device sends the first feedback information to the network device. If the first feedback information sent by the terminal device is a NACK, the terminal device does not generate the user-specific information based on the first channel information, and does not encrypt or scramble the signal to be transmitted between the terminal device and the network device based on the user-specific information. Correspondingly, if the first feedback information sent by the terminal device is a NACK, the network device does not generate the user-specific information based on the second channel information, and does not encrypt or scramble the signal to be transmitted between the terminal device and the network device based on the user-specific information. In addition, in this example, the network device may send the foregoing uniformly configured reference signal configuration information again.

For another example, after receiving the uniformly configured reference signal configuration information (including the configuration information of the first reference signal and the configuration information of the second reference signal) sent by the network device, the terminal device sends the first feedback information to the network device. If the first feedback information sent by the terminal device is an ACK and when T time units from the transmission time of the first feedback information expires, the terminal device encrypts or scrambles the signal to be transmitted between the terminal device and the network device by using the user-specific information generated based on the first channel information. Correspondingly, if the first feedback information sent by the terminal device is an ACK and when T time units from the transmission time of the first feedback information expires, the network device encrypts or scrambles the signal to be transmitted between the terminal device and the network device by using the user-specific information generated based on the second channel information.

For another example, after receiving the uniformly configured reference signal configuration information (including the configuration information of the first reference signal and the configuration information of the second reference signal) sent by the network device, the terminal device sends the first feedback information to the network device. If the first feedback information sent by the terminal device is a NACK, the terminal device does not generate the user-specific information based on the first channel information, and does not encrypt or scramble the signal to be transmitted between the terminal device and the network device based on the user-specific information. Correspondingly, if the feedback information sent by the terminal device is a NACK, the network device does not generate the user-specific information based on the second channel information, and does not encrypt or scramble the signal to be transmitted between the terminal device and the network device based on the user-specific information. In addition, in this example, the network device may send the foregoing uniformly configured reference signal configuration information again.

It should be noted that values of T in the foregoing different examples may be the same or different. For example, if a transmission time of the first feedback information serves as the reference time, the value of T may be the first value; and if the transmission time of the target reference signal (the reference signal having a later transmission time in the first reference signal and the second reference signal) serves as the reference time, the value of T may be the second value, and the first value may be greater than the second value.

It should be noted that the transmission time of the signal mentioned above may be represented by one or more of a subframe, a symbol, a slot, or a sub-slot where the signal is located. A time sequence of the transmission time of the signal may be determined based on one or more of: a transmission start time of the signal or a transmission end time of the signal.

For example, if a transmission start symbol of a signal 1 (that is, the first symbol occupied by transmission of the signal 1) is earlier than a transmission start symbol of a signal 2, a transmission time of the signal 1 is earlier than a transmission time of the signal 2.

For another example, if a transmission end symbol of a signal 1 (that is, the last symbol occupied by transmission of the signal 1) is earlier than a transmission end symbol of a signal 2, a transmission time of the signal 1 is earlier than a transmission time of the signal 2.

For another example, a transmission start symbol of a signal 1 and a transmission start symbol of a signal 2 may be compared first. If the transmission start symbol of the signal 1 is earlier than the transmission start symbol of the signal 2, the transmission time of the signal 1 is earlier than the transmission time of the signal 2. If the transmission start symbol of the signal 1 is the same as the transmission start symbol of the signal 2, the transmission end symbol of the signal 1 and the transmission end symbol of the signal 2 may be compared. If the transmission end symbol of the signal 1 is earlier than the transmission end symbol of the signal 2, the transmission time of the signal 1 is earlier than the transmission time of the signal 2. Otherwise, the transmission time of the signal 1 is later than the transmission time of the signal 2.

It should be noted that the time unit mentioned above may be represented by one of a subframe, a symbol, a slot, or a sub-slot. For example, T time units may refer to T subframes, T symbols, T slots, or T sub-slots.

It has been mentioned above that the user-specific information may be a target sequence, such as a reference signal sequence or a scrambling code sequence. The target sequence may be generated based on target channel information (the target channel information may be the first channel information or the second channel information mentioned above). For example, a target sequence initial seed may be generated based on the target channel information, and then the target sequence may be generated based on the target sequence initial seed. The following describes in detail a manner of generating the target sequence initial seed with reference to Embodiment 1 and Embodiment 2.

### Embodiment 1: Generating the Target Sequence Initial Seed Based on the Target Channel Information

In some embodiments, the target sequence initial seed may be generated based on feature information (or characteristic information or property information) of the target channel information.

Optionally, the feature information of the target channel information may include some or all features of the target channel information. For example, the target channel information is vector information, and the feature information of the target channel information may include feature information of the target channel information in a specific direction.

In some embodiments, the feature information of the target channel information includes but is not limited to at least one of: amplitude information of the target channel information, phase information of the target channel information, or mapping information (or projection information or quantization information) of the target channel information in a specific domain.

In some embodiments, the specific domain includes but is not limited to a Fourier transform (FT) domain, and in some specific embodiments, may include a fast Fourier transform (FFT) domain and a discrete Fourier transform (DFT) domain.

### Embodiment 1-1: Generating the Target Sequence Initial Seed Based on the Amplitude Information of the Target Channel Information

In some embodiments, the process of generating the target sequence initial seed based on the feature information of the target channel information may include: generating the target sequence initial seed based on amplitude information of channel information on N frequency domain units.

In some specific embodiments, the amplitude information of the channel information on the N frequency domain units may be quantized to obtain N amplitude quantization values. Then, the target sequence initial seed may be generated based on at least one amplitude quantization value in the N amplitude quantization values.

It should be understood that embodiments of this application do not limit a quantization manner of the amplitude information of the channel information on the N frequency domain units.

As an example, binary quantization may be performed on the amplitude information of the channel information on the N frequency domain units based on a first amplitude threshold to obtain N amplitude quantization values.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. Further, the first device (or the second device) may perform binary quantization on A(n) based on a first amplitude threshold Aₜₕ₁. For example, if A(n) is greater than Aₜₕ₁, A(n) is quantized to A′(n)=1. Otherwise, A(n) is quantized to A′(n)=0.

As another example, the amplitude information of the channel information on the N frequency domain units is rounded (for example, rounded up or rounded down) to obtain N amplitude quantization values.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. Further, the first device (or the second device) may quantize A(n) to A′(n)=┌A(n)┐ or A′(n)=└A(n)┘.

As still another example, the amplitude information of the channel information on the N frequency domain units modulo the second amplitude threshold is performed to obtain N amplitude quantization values.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. Further, the first device (or the second device) may perform modulo quantization on A(n) based on a second amplitude threshold Aₜₕ₂. For example, A(n) is quantized to A′(n)=A(n) mod Aₜₕ₂.

Further, in some embodiments, the first device (or the second device) may use one of the N amplitude quantization values as the target sequence initial seed, or may generate the target sequence initial seed based on a plurality of amplitude quantization values. For example, the plurality of amplitude quantization values are processed to obtain the target sequence initial seed, and the processing may include but is not limited to accumulation, multiplication, Fourier transform, modulo, etc.

As an example, the first device (or the second device) may generate the target sequence initial seed according to the following formula: C=Σᵢ₌₀^{Q}A′(i)·2ⁱ, where C represents the target sequence initial seed, A′(i) represents an amplitude quantization value of channel information on an i^{th} frequency domain unit in the N frequency domain units, Q is an integer, and A′(n) represents an amplitude quantization value of the channel information on the n^{th} frequency domain unit in the N frequency domain units.

### Embodiment 1-2: Generating the Target Sequence Initial Seed Based on the Phase Information of the Target Channel Information

In some embodiments, the process of generating the target sequence initial seed based on the feature information of the target channel information includes:
generating the target sequence initial seed based on phase information of channel information on the N frequency domain units.

In some specific embodiments, the phase information of the channel information on the N frequency domain units may be quantized to obtain N phase quantization values, and the target sequence initial seed may be generated based on at least one of the N phase quantization values.

It should be understood that this application does not limit the quantization manner of the phase information of the channel information on the N frequency domain units.

As an example, binary quantization is performed on the phase information of the channel information on the N frequency domain units based on a first phase threshold to obtain N phase quantization values.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. Further, the first device (or the second device) may perform binary quantization on θ(n) based on a first phase threshold θₜₕ₁. For example, if θ(n) is greater than θₜₕ₁, θ(n) is quantized to θ′(n)=1. Otherwise, θ(n) is quantized to θ′(n)=0.

As another example, the phase information of the channel information on the N frequency domain units is rounded (for example, rounded up or rounded down) to obtain N phase quantization values.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. Further, the first device (or the second device) may quantize θ(n) to θ′(n)=┌θ(n)┐ or θ′(n)=└θ(n)┘.

As still another example, the phase information of the channel information on the N frequency domain units modulo the second phase threshold is performed to obtain N phase quantization values.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. Further, the first device (or the second device) may perform modulo quantization on A(n) based on a second phase threshold θₜₕ₂. For example, θ(n) is quantized to θ′(n)=θ(n) mod θₜₕ₂.

In some embodiments, the first device (or the second device) may use one of the N phase quantization values as the target sequence initial seed, or may generate the target sequence initial seed based on a plurality of phase quantization values. For example, the plurality of phase quantization values are processed to obtain the target sequence initial seed, and the processing may include but is not limited to accumulation, multiplication, Fourier transform, modulo, etc.

As an example, the first device (or the second device) generates the target sequence initial seed according to the following formula: C=Σᵢ₌₀^{P}θ′(i)·2ⁱ, where C represents the target sequence initial seed, θ′(i) represents a phase quantization value of channel information on an i^{th} frequency domain unit in the N frequency domain units, P is an integer, and θ′(n) represents a phase quantization value of the channel information on the n^{th} frequency domain unit in the N frequency domain units.

### Embodiment 1-3: Generating the Target Sequence Initial Seed Based on the Mapping Information of the Target Channel Information in the Specific Domain

The following description is made by using an example in which the specific domain is the FFT domain, but this application is not limited thereto.

In some embodiments, the target sequence initial seed may be generated based on mapping information of channel information on the N frequency domain units in the Fourier transform domain.

In some embodiments, a codebook may be considered as the FFT domain, and mapping information of the target channel information in the FFT domain may be represented by a codebook mapped by the target channel information in the FFT domain.

In some specific embodiments, the first device (or the second device) may determine, in a candidate codebook set, a target codebook corresponding to channel information on each of the N frequency domain units based on the channel information on the frequency domain unit, where index information of the target codebook corresponding to the channel information on the frequency domain unit is used to represent mapping information of the channel information on the frequency domain unit in the Fourier transform domain.

Further, the target sequence initial seed is generated based on index information of a target codebook corresponding to channel information on at least one of the N frequency domain units.

It should be understood that in embodiments of this application, at least one may be one or more, where a plurality may be two or more.

It should be understood that embodiments of this application do not limit a specific manner of determining the target codebook corresponding to the channel information on each frequency domain unit in the candidate codebook set. In some embodiments, the target codebook may be determined based on the channel information on the frequency domain unit and an inner product of candidate codebooks in the candidate codebook set. In a specific embodiment, the target codebook is determined as a codebook in the candidate codebook set having the largest inner product with channel information on a frequency domain unit. In another specific embodiment, the target codebook is determined as a codebook in the candidate codebook set having the smallest inner product with channel information on a frequency domain unit.

For example, if channel information H_{a*b}(n) on an n^{th} frequency domain unit in the channel information on the N frequency domain units is expressed as:
H_{a*b}(n)=A(n)e^{jθ(n)}, n=0, 1, 2 . . . N−1, where A(n) represents amplitude information of the channel information on the n^{th} frequency domain unit, θ(n) represents phase information of the channel information on the n^{th} frequency domain unit, a represents a transmit antenna, and b represents a receive antenna. Further, the first device (or the second device) may determine a target codebook adapted to H_{a*b}(n) in the candidate codebook set, where in the candidate codebook set, an inner product of the target codebook and H_{a*b}(n) is the largest.

For example, as shown in Table 1, the candidate codebook set may include 256 codebooks, and an index i₁, i₂ corresponding to each codebook (corresponding to the foregoing index information) may be used to represent the codebook. A target codebook corresponding to the channel information on the n^{th} frequency domain unit in the N frequency domain units may be identified by i₁(n), i₂(n). Then, an index i₁(n), i₂(n) corresponding to the codebook may serve as mapping information of the channel information on the n^{th} frequency domain unit in the FFT domain.

TABLE 1

| | i₂ | | | | | | | |
|---|---|---|---|---|---|---|---|---|
| i₁ | 0 | 1 | 2 | 3 | 4 | 5 | 6 | 7 |
| 0 to | Wᵢ_{₁}_{,0}⁽¹⁾ | Wᵢ_{₁}_{,8}⁽¹⁾ | Wᵢ_{₁}_{,16}⁽¹⁾ | Wᵢ_{₁}_{,24}⁽¹⁾ | Wᵢ_{₁}_{+8,2}⁽¹⁾ | Wᵢ_{₁}_{+8,10}⁽¹⁾ | Wᵢ_{₁}_{+8,18}⁽¹⁾ | Wᵢ_{₁}_{+8,26}⁽¹⁾ |
| 15 | | | | | | | | |
| | i₂ | | | | | | | |
| i₁ | 8 | 9 | 10 | 11 | 12 | 13 | 14 | 15 |
| 0 to | Wᵢ_{₁}_{+16,4}⁽¹⁾ | Wᵢ_{₁}_{+16,12}⁽¹⁾ | Wᵢ_{₁}_{+16,20}⁽¹⁾ | Wᵢ_{₁}_{+16,28}⁽¹⁾ | Wᵢ_{₁}_{+24,6}⁽¹⁾ | Wᵢ_{₁}_{+24,14}⁽¹⁾ | Wᵢ_{₁}_{+24,22}⁽¹⁾ | Wᵢ_{₁}_{+24,30}⁽¹⁾ |
| 15 | | | | | | | | |

$Herein , {W}_{m , n}^{( 1 )} = \frac{1}{2} [ \begin{matrix}{v}_{m}^{′} \\ {φ}_{n}^{′} {v}_{m}^{′}\end{matrix} ] , \begin{matrix}{φ}_{n} = {e}^{j π n / 2} \\ {φ}_{n}^{′} = {e}^{j π n / 32} \\ {v}_{m}^{′} = [ \begin{matrix}1 & {{e}^{j 2 π m / 32} ]}^{T}\end{matrix}\end{matrix}$

A value of a codebook may be determined based on the index i₁, i₂ of the codebook with reference to a mapping relationship in Table 1. Specifically, first, values of m and n in W_{m,n}⁽¹⁾ may be determined based on a value of the index i₁, i₂ with reference to the mapping relationship in Table 1. For example, if i₁ ranges from 0 to 15 and i₂ is 0, the value of m is i₁, and n is 0, and further, with reference to the formula in the last row of Table 1, a value of W_{m,n}⁽¹⁾ is determined.

In some embodiments, the target sequence initial seed being generated based on index information of s target codebook corresponding to channel information on at least one of the N frequency domain units includes:
generating the target sequence initial seed according to the following formula:
C=Σₗ₌₀^{X}i₁(l)·15^{l}+Σₗ₊₀^{X}i₂(l)·15^{l}, where C represents the target sequence initial seed, i₁(l) and i₂(l) represent index information of a target codebook corresponding to the channel information on the i^{th} frequency domain unit in the N frequency domain units, X represents a result of a quantity of at least one frequency domain unit minus 1, and X is an integer.

It should be understood that Embodiment 1-1 to Embodiment 1-3 may be implemented alone, or may be implemented in combination. For example, in some embodiments, the first device (or the second device) may generate the target sequence initial seed based on the amplitude information and the phase information of the target channel information, or may generate the target sequence initial seed based on the amplitude information and the mapping information in the specific domain that are of the target channel information, or may generate the target sequence initial seed based on the amplitude information, the phase information, and the mapping information in the specific domain that are of the target channel information. As an example, the target sequence initial seed is generated according to the following formula:

$$C = {\sum }_{l = 0}^{X} {i}_{1} ( l ) \cdot {15}^{l} + {\sum }_{l = 0}^{X} {i}_{2} ( l ) \cdot {15}^{l} + {\sum }_{i = 0}^{Q} {A}^{′} ( i ) \cdot {2}^{i} + {\sum }_{i = 0}^{P} {θ}^{′} ( i ) \cdot {2}^{i}$$

Herein, C represents the target sequence initial seed, i₁(l) and i₂(l) represent index information of a target codebook corresponding to the channel information on the i^{th} frequency domain unit in the N frequency domain units, A′(n) represents an amplitude quantization value of the channel information on the n^{th} frequency domain unit in the N frequency domain units, θ′(i) represents a phase quantization value of the channel information on the i^{th} frequency domain unit in the N frequency domain units, X represents a result of a quantity of at least one frequency domain unit minus 1, X is an integer, Q is an integer, and P is an integer.

It should be understood that in this embodiment of this application, the target channel information may include the channel information on the N frequency domain units, or may include channel information on M other domain units (for example, in spatial domain), which is not limited in this application.

### Embodiment 2: Generating the Target Sequence Initial Seed Based on the Target Channel Information and Another Parameter

In some embodiments, the first device (or the second device) may generate the target sequence initial seed based on the target channel information and a first parameter, where the first parameter includes at least one of a time parameter, a configuration parameter, or a predefined parameter.

In some embodiments, the first device (or the second device) first generates a first sequence initial seed based on the target channel information, and further generates the target sequence initial seed based on the first sequence initial seed and the first parameter.

In some specific embodiments, the first sequence initial seed and the first parameter may be processed through accumulation, multiplication, modulo, or Fourier transformation to generate the target sequence initial seed.

In some other embodiments, the first device (or the second device) first generates a second sequence initial seed based on the first parameter, and further generates the target sequence initial seed based on the second sequence initial seed and the target channel information. As an example, the target sequence initial seed is generated based on the second sequence initial seed and the feature information of the target channel information.

It should be understood that in Embodiment 2, for specific implementation of generating the first sequence initial seed based on the target channel information, one may refer to the related description in Embodiment 1. For brevity, details are not described herein again.

For example, the first sequence initial seed is generated based on the feature information of the target channel information.

As an example, the first sequence initial seed is generated based on at least one of the amplitude information, the phase information, or the mapping information in the specific domain, of the target channel information.

### Embodiment 2-1: Generating the Target Sequence Initial Seed Based on the Target Channel Information and the Time Parameter

In some embodiments, the first device (or the second device) first quantizes the channel information on the N frequency domain units included in the target channel information, and further generates the target sequence initial seed based on the time parameter and the quantized channel information.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. Further, the first device (or the second device) may quantize H(n) to obtain H′(n). For a specific quantization manner, one may refer to the specific implementation of Embodiment 1. Further, the first device (or the second device) may process H′(n), n=0, 1 . . . N, to obtain a first sequence initial seed M. For example, M=f(H′(n)), and f is a function, such as an accumulation function, a multiplication function, or a Fourier transform function, which is not limited in this application.

Further, the first device (or the second device) obtains the target sequence initial seed according to the formula C=g(M, T), where g is a sequence generation function, such as an accumulation function, a multiplication function, a modulo function, or a Fourier transform function. T is a time parameter, and may be an index of a symbol, a slot, a subframe, a frame, or the like where the target sequence is located.

As an example, the target sequence initial seed C may be generated according to the following formula:

$$C = ( {2}^{17} ( {N}_{symb}^{slot} {n}_{s , f}^{μ} + l + 1 ) ( 2 M + 1 ) + 2 M ) mod {2}^{31} ,$$

where
l is a serial number of an orthogonal frequency division multiplexing (OFDM) symbol, N_{symb}^{slot} is a quantity of symbols within one slot, and n_{s,f}^{μ} is a slot serial number within a radio frame.

In Embodiment 2-1, during generation of the target sequence initial seed, the time parameter is introduced to increase a time-varying characteristic of the target sequence, thereby causing the target sequence difficult to be tracked and deciphered and implementing randomized interference to the target sequence, and thus reducing a security risk.

### Embodiment 2-2: Generating the Target Sequence Initial Seed Based on the Target Channel Information, the Time Parameter, and the Configuration Parameter

In some embodiments, the first device (or the second device) first quantizes the channel information on the N frequency domain units included in the target channel information, and further generates the target sequence initial seed based on the time parameter, the configuration parameter, and the quantized channel information.

For example, if channel information H(n) on an n^{th} frequency domain unit in the channel information on the N frequency domain units is expressed as:

$$H ( n ) = A ( n ) {e}^{j θ ( n )} ,$$

$$n = 0 , 1 , 2 … N - 1 ,$$

where A(n) represents amplitude information of the channel information on the n^{th} frequency domain unit, and θ(n) represents phase information of the channel information on the n^{th} frequency domain unit. Further, the first device (or the second device) may quantize H(n) to obtain H′(n). For a specific quantization manner, one may refer to the specific implementation of Embodiment 1. Further, the first device (or the second device) may process H′(n), n=0, 1 . . . N, to obtain a first sequence initial seed M. For example, M=f(H′(n)), and f is a function, such as an accumulation function, a multiplication function, a Fourier transform function, or the like, which is not limited in this application.

Further, the first device (or the second device) obtains the target sequence initial seed according to the formula C=g(M, T, P), where g is a sequence generation function, such as an accumulation function, a multiplication function, a modulo function, or a Fourier transform function. T is a time parameter, and may be an index of a symbol, a slot, a subframe, a frame, or the like where the target sequence is located. P is a configuration parameter.

As an example, the target sequence initial seed C may be generated according to the following formula:
C=(2¹⁷(N_{symb}^{slot}n_{s,f}^{μ}+l+1)(2M+1)+2M+P) mod 2³¹, where
l is a serial number of an OFDM symbol, N_{symb}^{slot} is a quantity of symbols within a slot, n_{s,f}^{μ} is a slot serial number in a radio frame, and P is a configuration parameter.

In Embodiment 2-2, during generation of the target sequence initial seed, the time parameter is introduced to increase a time-varying characteristic of the target sequence, thereby causing the target sequence difficult to be tracked and deciphered and implementing randomized interference to the target sequence, and thus reducing a security risk. A configuration parameter configured by the network device is introduced, so that the network device can control allocation of sequence resources, thereby being beneficial to interference coordination or elimination.

### Embodiment 2-3: Generating the Target Sequence Initial Seed Based on the Target Channel Information, the Time Parameter, and the Predefined Parameter

In some embodiments, the first device (or the second device) first quantizes the channel information on the N frequency domain units included in the target channel information, and further generates the target sequence initial seed based on the time parameter, the predefined parameter, and the quantized channel information.

For example, if channel information H(n) on an n^{th} frequency domain unit in the channel information on the N frequency domain units is expressed as:
H(n)=A(n)e^{jθ(n)}, n=0, 1, 2 . . . N−1, where A(n) represents amplitude information of the channel information on the n^{th} frequency domain unit, and θ(n) represents phase information of the channel information on the n^{th} frequency domain unit. The first device (or the second device) may quantize H(n) to obtain H′(n). For a specific quantization manner, one may refer to the specific implementation of Embodiment 1. Further, the first device (or the second device) may process H′(n), n=0, 1 . . . N, to obtain a first sequence initial seed M. For example, M=f(H′(n)), and f is a function, such as an accumulation function, a multiplication function, a Fourier transform function, or the like, which is not limited in this application.

Further, the first device (or the second device) obtains the target sequence initial seed according to the formula C=g(M, T, Y), where g is a sequence generation function, such as an accumulation function, a multiplication function, a modulo function, or a Fourier transform function. T is a time parameter, and may be an index of a symbol, a slot, a subframe, a frame, or the like where the target sequence is located. Y is a predefined parameter.

As an example, the target sequence initial seed C may be generated according to the following formula:
C=(2¹⁷(N_{symb}^{slot}n_{s,f}^{μ}+l+1)(2M+1)+2M+Y) mod 2³¹, where
l is a serial number of an OFDM symbol, N_{symb}^{slot} is a quantity of symbols within a slot, n_{s,f}^{μ} is a slot serial number in a radio frame, and P is a predefined parameter.

As mentioned above, the first reference signal may be a CSI-RS, and the second reference signal may be an SRS. Configuration for the first reference signal and configuration for the second reference signal are described below in more detail with reference to Embodiment 3 by using an example in which the first reference signal is a CSI-RS and the second reference signal is an SRS. It should be understood that a configuration parameter of a reference signal described in Embodiment 3 may be combined with some configuration parameters of the reference signals mentioned above. For example, the association indexes of the first reference signal and the second reference signal mentioned above may be added to the CSI-RS and the SRS described in Embodiment 3.

### Embodiment 3.1: The First Reference Signal Being a CSI-RS

CSI-RS configuration information may include configuration information of a plurality of non-zero-power (NZP) CSI-RS resource sets. That is, one or more NZP CSI-RS resource sets may be configured for the first device.

In some embodiments, the plurality of NZP CSI-RS resource sets may be configured by higher layer parameters. The higher layer parameter may be, for example, a radio resource control (RRC) parameter. The higher layer parameter may include one or more of NZP CSI RS resource, CSI ResourceConfig, or NZP CSI RS ResourceSet.

In some embodiments, each of the one or more NZP CSI-RS resource sets may include K (K is a positive integer greater than or equal to 1) NZP CSI-RS resources (hereinafter the NZP CSI-RS resources are referred to as CSI-RS resources).

In some embodiments, the configuration information of the CSI-RS resource may include one or more of the following configuration parameters:
NZP CSI RS ResourceId: this parameter may be used to indicate an identity of the CSI-RS resource.
periodicity AndOffset: this parameter may be used to indicate a periodicity and a slot offset of a periodic/semi-persistent CSI-RS. CSI-RS resources configured by the first device may include one or more groups of CSI-RS resources. Further, CSI-RS resources within one group may be set to have the same periodicity. In addition, slot offsets corresponding to different CSI-RS resources may be the same or different.
resourceMapping: this parameter may be used to indicate one or more of a quantity of ports, a CDM-type, an OFDM symbol, or subcarrier occupancy of the CSI-RS resource within a slot.
nrofPorts in resourceMapping: this parameter may be used to indicate a quantity of CSI-RS ports.
density in resourceMapping: this parameter may be used to indicate CSI-RS frequency density of each CSI-RS port per physical resource block (PRB) and a CSI-RS PRB offset in case of a density value of ½. For density ½, even/odd PRB allocation indicated in the density is related to a common resource block grid.
CDM-type in resourceMapping: this parameter may be used to indicate a CDM value and a pattern.
powerControlOffset: this parameter may be used to indicate an assumed ratio of a physical downlink shared channel (PDSCH) energy per resource element (EPRE) to an NZP CSI-RS EPRE when the first device obtains CSI feedback. A value range of the assumed ratio may be set to [−8, 15] dB. In addition, a step size of the assumed ratio may be set to 1 dB. For calculation of a channel quality indicator (CQI) based on a pair of CSI-RS resources, powerControlOffset of each CSI-RS resource in the pair of CSI-RS resources for channel measurement is the assumed ratio of the EPREs when the first device derives the CSI feedback and takes values in the range of [−8, 15] dB (with a step size of 1 dB).
powerControlOffsetSS: this parameter may be used to indicate an assumed ratio of an NZP CSI-RS EPRE to a synchronization signal and physical broadcast channel (SS/PBCH) block EPRE.
scramblingID (identtity): this parameter may be used to indicate a scrambling ID of a CSI-RS. A length of the scrambling ID of the CSI-RS may be 10 bits.
BWP-Id in CSI-ResourceConfig: this parameter may be used to indicate a bandwidth part (bandwidth part, BWP) in which a CSI-RS is located.
repetition in NZP-CSI-RS-ResourceSet: this parameter is associated with a CSI-RS resource set. This parameter may be used to indicate whether the first device may assume that CSI-RS resources in the NZP CSI-RS resource set are transmitted with the same downlink spatial domain transmission filter, or assume that the CSI-RS resources in the NZP CSI-RS resource set do not use a transmission filter. A CSI-RS resource set may be associated with one or more reports. This parameter may be configured when reportQuantity associated with the one or more reports is set to “cri reference signal received power (RSRP)”, “cri signal to interference plus noise ratio (SNR)”, or “none”.
qcl-InfoPeriodicCSI-RS: this parameter may include a reference to a TCI-State. This parameter may indicate a quasi co-location (QCL) source RS and a QCL type.
trs-Info in a CSI RS resource set.

### Embodiment 3.2: The Second Reference Signal Being an SRS

SRS configuration information may be configured by higher layer parameters (for example, semi-statically configured by higher layer parameters). The higher layer parameter may be an RRC parameter. The higher layer parameter may include one or more of an SRS Resource or SRS PosResource.

In some embodiments, the SRS configuration information may include one or more of the following information:
srs ResourceId or srs PosResourceId. This parameter may be used to indicate an identity of an srs resource configuration.
Quantity of SRS ports. This parameter may be defined by a higher layer parameter nrofSRS-Ports. If this parameter is not configured, nrofSRS-Ports may be set to 1.
Time domain behavior of an SRS resource configuration. The time domain behavior may be indicated by a higher layer parameter resourceType. The time domain behavior may be, for example, periodic, semi-persistent, or aperiodic SRS transmission.
Slot level periodicity and slot level offset. The parameters may be defined by higher layer parameters periodicityAndOffset-p or periodicityAndOffset-sp for periodic or semi-persistent type SRS resources.
Quantity of OFDM symbols in an SRS resource and a starting OFDM symbol of the SRS resource within a slot.
SRS bandwidth.
Frequency hopping bandwidth. This parameter may be defined by a higher layer parameter freqHopping.
This parameter defines a partial frequency sounding factor and a start RB index for partial frequency sounding, which are respectively defined by higher layer parameters FreqScalingFactor P_{F} and StartRBIndex k_{F}. If not configured, P_{F}=1, and k_{F}=0.
Hopping pattern k_{hopping}. This parameter defines start RB index hopping for partial frequency sounding in different SRS frequency hopping periods for an aperiodic/periodic/semi-persistent SRS. If not configured, start RB hopping is not enabled, and k_{hopping} is fixed to 0 for all SRS symbols.
This parameter defines a frequency domain location and a configurable shift, which are respectively defined by higher layer parameters freqDomainPosition and freqDomainShift. If freqDomainPosition is not configured, freqDomainPosition is zero.
Cyclic shift. This parameter is defined by a higher layer parameter cyclicShift-n2, cyclicShift-n4, or cyclicShift-n8 for a transmission comb value 2, 4 or 8.
Transmission comb value. This parameter is defined by a higher layer parameter transmissionComb.
Transmission comb offset. This parameter is defined by a higher layer parameter combOffset-n2, combOffset-n4, or combOffset-n8 for a transmission comb value 2, 4, or 8.
SRS sequence ID. This parameter is defined by a higher layer parameter sequenceId.
Configuration of a spatial relation between a reference RS and a target SRS. A higher layer parameter spatialRelationInfo or spatialRelationInfoPos (if configured) includes an ID of a reference RS. The reference RS may be an SS/PBCH block, a CSI-RS configured on a serving cell indicated by a higher layer parameter servingCellId (if present), otherwise on the same serving cell as a target SRS, or an SRS configured on an uplink BWP indicated by a higher layer parameter uplinkBWP and a serving cell indicated by the higher layer parameter servingCellId (if present), otherwise on the same serving cell as the target SRS. When the target SRS is configured by a higher layer parameter SRS-PosResourceSet, the reference RS may be alternatively a DL positioning reference signal (positioning reference signal, PRS) configured on a serving cell or a non-serving cell indicated by a higher layer parameter dl-PRS, or an SS/PBCH block of a non-serving cell indicated by a higher layer parameter ssb-Ncell. The communications device (such as the foregoing first device) is configured with [TCI-State] with [tci-StateId_r17].

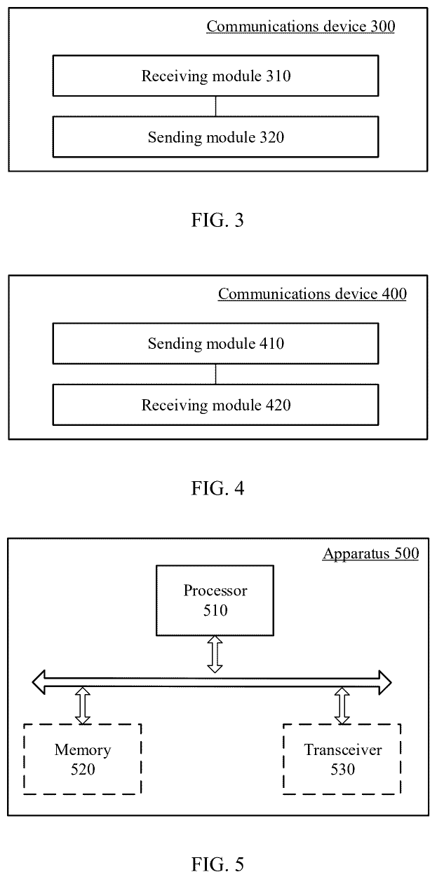

The method embodiments of this application are described in detail above with reference to FIG. 1 and FIG. 2. Apparatus embodiments of this application are described in detail below with reference to FIG. 3 to FIG. 5. It should be understood that the description of the method embodiments corresponds to the description of the apparatus embodiments, and therefore, for a part that is not described in detail, reference may be made to the foregoing method embodiments.

FIG. 3 is a schematic diagram of a structure of a communications device according to an embodiment of this application.

A communications device 300 shown in FIG. 3 may be the first device mentioned above. The communications device 300 may include a receiving module 310 and a sending module 320. The receiving module 310 may be configured to receive a first reference signal from a second device based on configuration information of the first reference signal. The sending module 320 may be configured to send a second reference signal to the second device based on configuration information of the second reference signal. The first reference signal and the second reference signal are respectively used to determine first channel information and second channel information, and the first channel information and the second channel information are the same.

Optionally, in some embodiments, the configuration information of the first reference signal and the configuration information of the second reference signal are both configuration information for a first link, the first link is a communication link with two transmission directions, and the two transmission directions include a transmission direction from the first device to the second device, and a transmission direction from the second device to the first device.

Optionally, in some embodiments, the first reference signal and the second reference signal are uniformly configured reference signals.

Optionally, in some embodiments, some or all configuration parameters of the first reference signal and the second reference signal are shared parameters of the first reference signal and the second reference signal.

Optionally, in some embodiments, some configuration parameters of the second reference signal are determined based on the configuration information of the first reference signal, or some configuration parameters of the first reference signal are determined based on the configuration information of the second reference signal.

Optionally, in some embodiments, the some configuration parameters include configuration parameters having corresponding values in the first reference signal and the second reference signal.

Optionally, in some embodiments, the some configuration parameters include one or more of a frequency domain location of a reference signal or spatial information of a reference signal.

Optionally, in some embodiments, the first reference signal and the second reference signal are a pair of reference signals having a pairing relationship in independently configured reference signals.

Optionally, in some embodiments, the configuration information of the first reference signal includes first information for indicating the pairing relationship, and/or the configuration information of the second reference signal includes second information for indicating the pairing relationship.

Optionally, in some embodiments, the first information is a first index, the second information is a second index, and the first index corresponds to the second index.

Optionally, in some embodiments, the first reference signal and the second reference signal having a pairing relationship meet a first condition, and the first condition is associated with one or more of: spatial information of the first reference signal and spatial information of the second reference signal; or a frequency domain location of the first reference signal and a frequency domain location of the second reference signal.

Optionally, in some embodiments, the first condition includes one or more of: that a received beam of the first reference signal is the same as a transmitted beam of the second reference signal; that a transmitted beam of the first reference signal is the same as a received beam of the second reference signal; or that the frequency domain location of the first reference signal is the same as the frequency domain location of the second reference signal.

Optionally, in some embodiments, spatial information of the first reference signal is associated to the second reference signal, or the spatial information of the second reference signal is associated to the first reference signal.

Optionally, in some embodiments, the communications device 300 further includes: a generating module, configured to generate user-specific information based on the first channel information.

Optionally, in some embodiments, an effective time of the user-specific information is determined based on a first reference time, and the first reference time is determined based on one or more of: a transmission time of the first reference signal; a transmission time of the second reference signal; or a transmission time of first feedback information, where the first feedback information is used to indicate that the first device successfully receives reference signal configuration information, and the reference signal configuration information includes the configuration information of the first reference signal and the configuration information of the second reference signal.

Optionally, in some embodiments, the effective time of the user-specific information is equal to or later than a first time, and the first time is determined based on T time units after the first reference time, where T is a positive integer greater than or equal to 1.

Optionally, in some embodiments, the first reference time is a transmission time of a target reference signal, where the target reference signal is a reference signal that has a later transmission time in the first reference signal and the second reference signal; or the first reference time is the transmission time of the first feedback information.

Optionally, in some embodiments, the first reference signal and the second reference signal are respectively a downlink reference signal and an uplink reference signal, or the first reference signal and the second reference signal are both sidelink reference signals.

Optionally, in some embodiments, the first reference signal and the second reference signal are both used to generate user-specific information.

FIG. 4 is a schematic diagram of a structure of a communications device according to another embodiment of this application.

A communications device 400 in FIG. 4 may be the second device mentioned above. The communications device 400 may include a sending module 410 and a receiving module 420. The sending module 410 may be configured to send a first reference signal to a first device based on configuration information of the first reference signal. The receiving module 420 may be configured to receive a second reference signal from the first device based on configuration information of the second reference signal. The first reference signal and the second reference signal are respectively used to determine first channel information and second channel information, and the first channel information and the second channel information are the same.

Optionally, in some embodiments, the configuration information of the first reference signal and the configuration information of the second reference signal are both configuration information for a first link, the first link is a communication link with two transmission directions, and the two transmission directions include a transmission direction from the first device to the second device, and a transmission direction from the second device to the first device.

Optionally, in some embodiments, the first reference signal and the second reference signal are uniformly configured reference signals.

Optionally, in some embodiments, some or all configuration parameters of the first reference signal and the second reference signal are shared parameters of the first reference signal and the second reference signal.

Optionally, in some embodiments, some configuration parameters of the second reference signal are determined based on the configuration information of the first reference signal, or some configuration parameters of the first reference signal are determined based on the configuration information of the second reference signal.

Optionally, in some embodiments, the some configuration parameters include configuration parameters having corresponding values in the first reference signal and the second reference signal.

Optionally, in some embodiments, the some configuration parameters include one or more of a frequency domain location of a reference signal or spatial information of a reference signal.

Optionally, in some embodiments, the first reference signal and the second reference signal are a pair of reference signals having a pairing relationship in independently configured reference signals.

Optionally, in some embodiments, the configuration information of the first reference signal includes first information for indicating the pairing relationship, and/or the configuration information of the second reference signal includes second information for indicating the pairing relationship.

Optionally, in some embodiments, the first information is a first index, the second information is a second index, and the first index corresponds to the second index.

Optionally, in some embodiments, the first reference signal and the second reference signal having a pairing relationship meet a first condition, and the first condition is associated with one or more of: spatial information of the first reference signal and spatial information of the second reference signal; or a frequency domain location of the first reference signal and a frequency domain location of the second reference signal.

Optionally, in some embodiments, the first condition includes one or more of: that a received beam of the first reference signal is the same as a transmitted beam of the second reference signal; that a transmitted beam of the first reference signal is the same as a received beam of the second reference signal; or that the frequency domain location of the first reference signal is the same as the frequency domain location of the second reference signal.

Optionally, in some embodiments, spatial information of the first reference signal is associated to the second reference signal, or the spatial information of the second reference signal is associated to the first reference signal.

Optionally, in some embodiments, the communications device 400 may further include: a generating module, configured to generate user-specific information based on the second channel information.

Optionally, in some embodiments, an effective time of the user-specific information is determined based on a first reference time, and the first reference time is determined based on one or more of: a transmission time of the first reference signal; a transmission time of the second reference signal; or a transmission time of first feedback information, where the first feedback information is used to indicate that the first device successfully receives reference signal configuration information, and the reference signal configuration information includes the configuration information of the first reference signal and the configuration information of the second reference signal.

Optionally, in some embodiments, the effective time of the user-specific information is equal to or later than a first time, and the first time is determined based on T time units after the first reference time, where T is a positive integer greater than or equal to 1.

Optionally, in some embodiments, the first reference time is a transmission time of a target reference signal, where the target reference signal is a reference signal that has a later transmission time in the first reference signal and the second reference signal; or the first reference time is the transmission time of the first feedback information.

Optionally, in some embodiments, the first reference signal and the second reference signal are respectively a downlink reference signal and an uplink reference signal, or the first reference signal and the second reference signal are both sidelink reference signals.

Optionally, in some embodiments, the first reference signal and the second reference signal are both used to generate user-specific information.

FIG. 5 is a schematic diagram of a structure of an apparatus according to an embodiment of this application. Dashed lines in FIG. 5 indicate that a unit or module is optional. The apparatus 500 may be configured to implement the methods described in the foregoing method embodiments. The apparatus 500 may be a chip or a communications device. The communications device may be, for example, the first device or the second device mentioned above.

The apparatus 500 may include one or more processors 510. The processor 510 may allow the apparatus 500 to implement the methods described in the foregoing method embodiments. The processor 510 may be a general-purpose processor or a dedicated processor. For example, the processor may be a central processing unit (CPU). Alternatively, the processor 510 may be another general-purpose processor, a digital signal processor (digital signal processor, DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 500 may further include one or more memories 520. The memory 520 stores a program that may be executed by the processor 510, so that the processor 510 performs the method described in the foregoing method embodiments. The memory 520 may be independent of the processor 510 or may be integrated into the processor 510.

The apparatus 500 may further include a transceiver 530. The processor 510 may communicate with another device or chip by using the transceiver 530. For example, the processor 510 may transmit and receive data to and from another device or chip by using the transceiver 530.

In some embodiments, the apparatus 500 may be located in the communications device 300 in FIG. 3. The receiving module 310 and the sending module 320 in the communications device 300 may correspond to the transceiver in the apparatus 500. Alternatively, functions of the receiving module 310 and the sending module 320 may be implemented by the transceiver 530 in the apparatus 500 under the control of the processor 510.

In some embodiments, the apparatus 500 may be located in the communications device 400 in FIG. 4. The sending module 410 and the receiving module 420 in the communications device 400 may correspond to the transceiver in the apparatus 500. Alternatively, functions of the sending module 410 and the receiving module 420 may be implemented by the transceiver 530 in the apparatus 500 under the control of the processor 510.

An embodiment of this application further provides a computer-readable storage medium for storing a program. The computer-readable storage medium may be applied to the communications device provided in embodiments of this application, and the program causes a computer to perform the methods to be performed by the communications device in various embodiments of this application.

An embodiment of this application further provides a computer program product. The computer program product includes a program. The computer program product may be applied to the communications device provided in embodiments of this application, and the program causes a computer to perform the methods to be performed by the communications device in various embodiments of this application.

An embodiment of this application further provides a computer program. The computer program may be applied to the terminal device or the network device provided in embodiments of this application, and the computer program causes a computer to perform the methods performed by the communications device in various embodiments of this application.

It should be noted that in embodiments of this application, “indicate” mentioned herein may refer to a direct indication, or may refer to an indirect indication, or may mean that there is an association. For example, A indicates B, which may mean that A directly indicates B, for example, B may be obtained by means of A; or may mean that A indirectly indicates B, for example, A indicates C, and B may be obtained by means of C; or may mean that there is an association between A and B.

In description of embodiments of this application, the term “corresponding” may mean that there is a direct or indirect correspondence between the two, or may mean that there is an association between the two, or may be a relationship such as indicating and being indicated, or configuring and being configured.

“configuration” in embodiments of this application may include configuration performed by at least one of a system message, radio resource control (RRC) signalling, or a media access control control element (MAC CE).

In some embodiments of this application, “predefined” or “preset” may be implemented by pre-storing corresponding codes, tables, or other forms that can be used to indicate related information in devices (for example, including the terminal device and the network device), and a specific implementation thereof is not limited in this application. For example, predefined may refer to defined in the protocol.

In some embodiments of this application, the “protocol” may refer to a standard protocol in the communications field, and may include, for example, an LTE protocol, an NR protocol, and a related protocol applied to a future communications system, which is not limited in this application.

It should be understood that, the term “and/or” herein is merely an association that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication device, wherein the communication device is a first device comprising at least one processor and at least one memory including computer program, wherein the at least one memory and the at least one processor are configured with the computer program, to cause the first device at least to:
receive a first reference signal from a second device based on configuration information of the first reference signal; and
send a second reference signal to the second device based on configuration information of the second reference signal, wherein
the first reference signal and the second reference signal are respectively used to determine first channel information and second channel information, and the first channel information and the second channel information are the same.

2. The communication device according to claim 1, wherein the configuration information of the first reference signal and the configuration information of the second reference signal are both configuration information for a first link, the first link is a communication link with two transmission directions, and the two transmission directions comprise a transmission direction from the first device to the second device, and a transmission direction from the second device to the first device.

3. The communication device according to claim 1, wherein the first reference signal and the second reference signal are uniformly configured reference signals.

4. The communication device according to claim 3, wherein some or all configuration parameters of the first reference signal and the second reference signal are shared parameters of the first reference signal and the second reference signal.

5. The communication device according to claim 3, wherein some configuration parameters of the second reference signal are determined based on the configuration information of the first reference signal, or some configuration parameters of the first reference signal are determined based on the configuration information of the second reference signal.

6. The communication device according to claim 1, wherein the first reference signal and the second reference signal are a pair of reference signals having a pairing relationship in independently configured reference signals.

7. The communication device according to claim 6, wherein the first reference signal and the second reference signal having a pairing relationship meet a first condition, and the first condition is associated with one or more of:
spatial information of the first reference signal and spatial information of the second reference signal; or
a frequency domain location of the first reference signal and a frequency domain location of the second reference signal.

8. The communication device according to claim 7, wherein the first condition comprises one or more of:
that a received beam of the first reference signal is the same as a transmitted beam of the second reference signal;
that a transmitted beam of the first reference signal is the same as a received beam of the second reference signal; or
that the frequency domain location of the first reference signal is the same as the frequency domain location of the second reference signal.

9. The communication device according to claim 1, wherein spatial information of the first reference signal is associated to the second reference signal, or the spatial information of the second reference signal is associated to the first reference signal.

10. The communication device according to claim 1, wherein the first device is further configured to:
generate, by the first device, user-specific information based on the first channel information.

11. The communication device according to claim 10, wherein an effective time of the user-specific information is determined based on a first reference time, and the first reference time is determined based on one or more of:
a transmission time of the first reference signal;
a transmission time of the second reference signal; or
a transmission time of first feedback information, wherein the first feedback information is used to indicate that the first device successfully receives reference signal configuration information, and the reference signal configuration information comprises the configuration information of the first reference signal and the configuration information of the second reference signal.

12. The communication device according to claim 11, wherein the effective time of the user-specific information is equal to or later than a first time, and the first time is determined based on T time units after the first reference time, wherein T is a positive integer greater than or equal to 1.

13. A communication device, wherein the communication device is a second device comprising at least one processor and at least one memory including computer program, wherein the at least one memory and the at least one processor are configured with the computer program, to cause the second device at least to:
send a first reference signal to a first device based on configuration information of the first reference signal; and
receive a second reference signal from the first device based on configuration information of the second reference signal, wherein
the first reference signal and the second reference signal are respectively used to determine first channel information and second channel information, and the first channel information and the second channel information are the same.

14. The communication device according to claim 13, wherein the configuration information of the first reference signal and the configuration information of the second reference signal are both configuration information for a first link, the first link is a communication link with two transmission directions, and the two transmission directions comprise a transmission direction from the first device to the second device, and a transmission direction from the second device to the first device.

15. The communication device according to claim 13, wherein the first reference signal and the second reference signal are uniformly configured reference signals.

16. The communication device according to claim 15, wherein some or all configuration parameters of the first reference signal and the second reference signal are shared parameters of the first reference signal and the second reference signal.

17. The communication device according to claim 15, wherein some configuration parameters of the second reference signal are determined based on the configuration information of the first reference signal, or some configuration parameters of the first reference signal are determined based on the configuration information of the second reference signal.

18. The communication device according to claim 13, wherein the first reference signal and the second reference signal are a pair of reference signals having a pairing relationship in independently configured reference signals.

19. The communication device according to claim 18, wherein the first reference signal and the second reference signal having a pairing relationship meet a first condition, and the first condition is associated with one or more of:
spatial information of the first reference signal and spatial information of the second reference signal; or
a frequency domain location of the first reference signal and a frequency domain location of the second reference signal.

20. A wireless communication method, comprising:
receiving, by a first device, a first reference signal from a second device based on configuration information of the first reference signal; and
sending, by the first device, a second reference signal to the second device based on configuration information of the second reference signal, wherein
the first reference signal and the second reference signal are respectively used to determine first channel information and second channel information, and the first channel information and the second channel information are the same.
